(19) United States
(12) Patent Application Publication
(10) Pub. No.: US 2007/0262580 A1
(43) Pub. Date: Nov. 15, 2007

(54) Self Adherent Greeting Cards and Envelopes

(76) Inventors: Richard E. Wronski, Barre, MA (US); John B. Rabel, Hollidaysburg, PA (US)

Correspondence Address: MEADWESTVACO CORPORATION, 1021 MAIN CAMPUS DRIVE, 3RD FLOOR, CENTENNIAL CAMPUS, RALEIGH, NC, 27606, US

(21) Appl. No.: 11/746,406

(22) Filed: May 9, 2007

Related U.S. Application Data
(60) Provisional application No. 60/798,954, filed on May 9, 2006.

(51) Int. Cl. B42D 15/00

(52) U.S. Cl. 283/116

(57) ABSTRACT

The invention teaches a greeting card with a releasable adhesive for first attaching to an envelope and later attaching to a display surface.

### REFERENCE TO RELATED APPLICATION

This application claims the benefit of priority under 35 U.S.C. §119(e) of U.S. provisional application Ser. No. 60/798,954, filed on May 9, 2006, which is hereby incorporated by reference in its entirety.

### BACKGROUND

This invention is directed to a method for removably adhering greeting cards to their intended envelopes, and for removably adhering greeting or post cards to display surfaces.

Greeting cards are typically sold by placing the cards in retail store racks, where a stack of several of each type of card is placed in a slot on the rack, usually with the corresponding envelopes placed directly behind the cards. When the customer has selected a card, she takes it along with one of the corresponding envelopes. The envelopes are preselected by the manufacturer according to such factors as proper size, matching color, paper type, or other aesthetic considerations, appropriate marking (such as “extra postage required” for large cards), and so forth. There is a certain amount of diligence and work required from the manufacturer and the retailer to supply the correct envelope with each greeting card, and to keep the envelope and card together prior to purchase.

Because the cards and envelopes are not physically connected, envelopes may become misplaced, and if the supply of suitable envelopes is exhausted, and the customer must search among other card slots for a suitable envelope. This propagates the problem to other cards.

Upon receipt of greeting cards, many people like to display the cards. For example, during the Christmas season, cards may be attached to walls, doors, refrigerators, and like display surfaces. Typically the recipient may tape the cards to the display surface, either by a simple piece of tape partially attached to a front-facing surface of the card and onto the display surface, or by a loop of tape with the adhesive facing outward, so that the tape loop may provide a hidden attachment of the rear-facing card surface to the display surface. Another alternative is to use push pins or tacks to attach the cards.

Use of tape to attach a card to a display surface has some disadvantages. A tape dispenser must be available, and if care is not taken, the card may suffer some cosmetic damage when the tape is eventually removed. Push pins create holes in cards, and may damage some display surfaces.

U.S. Pat. No. 6,725,587 teaches a structure of a greeting card and envelope manufactured from a single blank, with coinciding portions. After mailing the structure is opened, and portions of the envelope may be removed via perforations. However, the edges of the greeting card thereby show perforation marks.

U.S. Pat. No. 4,070,778 discloses a greeting card with a pressure sensitive adhesive on its back for attaching to a display surface. U.S. Pat. No. 5,458,282 discloses a greeting card having a magnetic sheet material for attaching the card to a display surface. However, these greeting cards do not have a means to keep the card and envelope together.

What is needed is a method to keep suitable envelopes together with the greeting cards for which they are intended. It would be advantageous if the method also provided a convenient way to attach received greeting cards to display surfaces.

### SUMMARY

A method is disclosed for retaining a greeting card with its intended envelope by use of a removable adhesive. In one embodiment, a removable adhesive is applied to the back of the greeting card. In another embodiment, a removable adhesive is applied to the inside of the intended envelope. In certain embodiments, a release liner is used to cover at least a portion of the adhesive.

### BRIEF DESCRIPTION OF THE DRAWINGS

FIG. 1 illustrates an exemplary view of a greeting card with an adhesive strip according to the invention;

FIG. 2 illustrates an exemplary view of a greeting card with an adhesive strip in an alternate location;

FIG. 3 illustrates the greeting card of FIG. 1 juxtaposed upon an envelope;

FIG. 4 illustrates the greeting card and envelope combination of FIG. 3 with the card partly opened.

### DETAILED DESCRIPTION

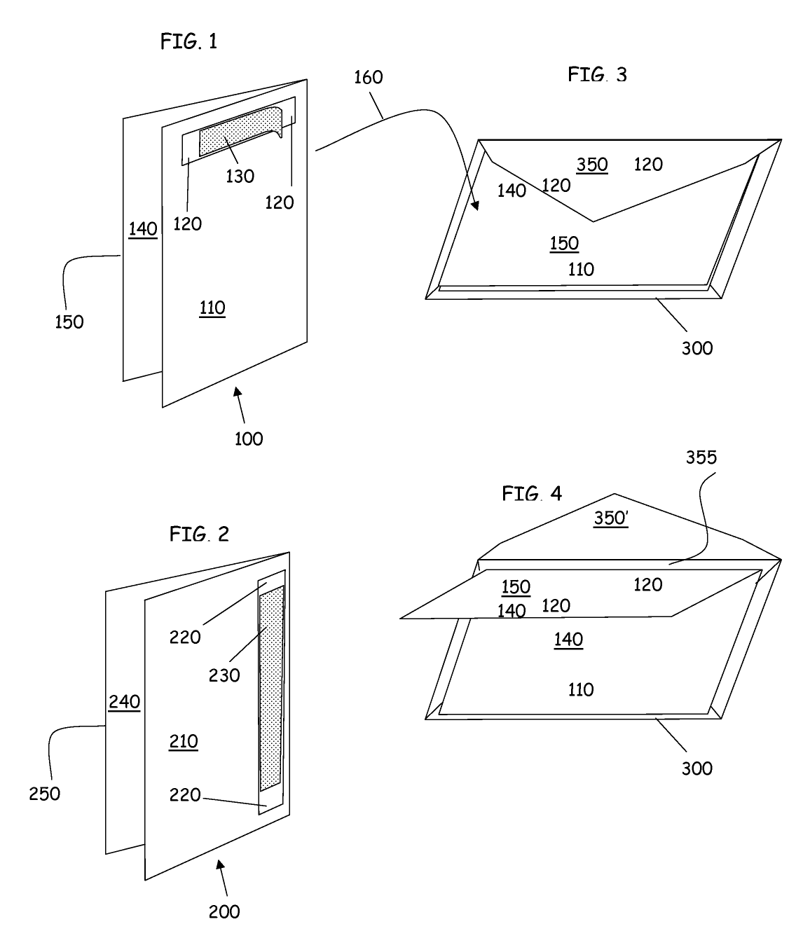

FIG. 1 illustrates an exemplary greeting card 100 according to one embodiment of the invention. Such a greeting card may typically be made by first forming a card blank (not shown) of one or more panels (in this case, two panels), printing graphics on the blank, and folding the blank (if there are more than one panel). The greeting card 100 has a back surface 110 and a front surface 150. In this example, greeting card 100 has two panels, so that it has one or more internal surfaces 140 (in this case, two internal surfaces).

A removable adhesive may be provided on the back surface 110, such as on an area 120 shown in the form of a rectangular strip area near a top edge. At least a portion of the area 120 is left exposed, but in one embodiment, a portion is covered by a release liner 130.

FIG. 2 illustrates an alternative placement of the adhesive area in an exemplary greeting card 200 according to an embodiment of the invention. In this example, greeting card 200 has two panels, so that it has a back surface 210, a front surface 250, and one or more internal surfaces 240.

A removable adhesive may be provided on the back surface 210, such as on an area 220 shown in the form of a rectangular strip area near a spine or folded edge. At least a portion of the area 220 is left exposed, but in certain embodiments a portion is covered by a release liner 230.

FIG. 3 illustrates the greeting card of FIG. 1, placed back side (110) down upon envelope 300, by inverting the card as illustrated by motion arrow 160. The card 100 may be placed anywhere upon the envelope 300, but it is preferably placed so that it is ‘nestled’ between the envelope 300 and the envelope flap 305. In this nestling placement, most of the front surface 150 of card 100 will be visible when the card is placed, along with the juxtaposed envelope, in a retail display rack. If it is desired for the entire front surface 150 of the card to be visible, the card may be placed in alternate locations upon the envelope, for example with the envelope flap 305 behind the card 100 (not shown), or on the other side of the envelope (not shown).

In another embodiment of the invention, the adhesive to join the greeting card and the envelope may be placed on the envelope instead of the greeting card. For example, an adhesive may be placed inside the envelope, under the flap 350, in an area approximately denoted as 355 in FIG. 4.

A variety of adhesives may be used. For example, the adhesive may be a cold extruded glue that may be applied under pressure by means of spraying or applying through an orifice. The adhesive may be a cold pickered glue that may be rolled on by means of a picker, similar to a paint roller. The adhesive may be a hot melt extruded glue, for example applied under pressure by means of applying or spraying through an orifice. The adhesive may be a hot melt combed glue, that is applied by dipping a comb in hot glue and then transferring the glue to the surface to be glued. A latex adhesive may be used. A fugitive type of adhesive may be used. Other adhesives may also be used.

FIG. 4 illustrates how the greeting card 100 and envelope 300 combination of FIG. 3 appears when the assembly is opened up, as when a customer removes the card and envelope from a retail display rack. The entire front surface 150 is visible when the envelope flap (shown from its inside surface 350′) is folded upward. The inside surfaces 140 of the card are also readily accessible. The back surface 110 (not shown) is attached to the envelope by at least part of adhesive area 120, so the back surface may not be immediately visible, but can still be inspected (for example, to see the price or the brand name) by flexing the card forward, or even temporarily removing it from adhering to the envelope.

If the customer chooses to purchase the greeting card 100, there is no need to search for a suitable envelope, since suitable envelope 300 is already attached to the greeting card. Upon purchase of the card, the customer may write upon the card and envelope, detach the card from the envelope, place the card into the envelope and mail it.

The recipient of card 100 may then remove it from envelope 300 and read the card. If the recipient wishes to display the card, in embodiments having the adhesive on the card, she is afforded the convenience of simply removing the release liner 130, and then attaching the card to a suitable display surface such as a window, door, refrigerator, etc., where it is held by the temporary adhesive area 120. The temporary adhesive allows the card 100 to eventually be removed from the display surface without damaging the card or the display surface.

It is to be understood therefore that the invention is not limited to the particular embodiments disclosed (or apparent from the disclosure) herein, but only limited by the claims appended hereto.

What is claimed is:

1. A method of retaining a greeting card with its intended envelope comprising the steps of:
A) forming a greeting card comprising the steps of:
1) providing a greeting card blank comprising a front panel and an optional one or more additional panels;
2) converting the greeting card blank into the final shape of the greeting card; whereby the greeting card has a front outer facing surface and a rear outer facing surface;
3) placing a removable adhesive on at least some portion of the rear outer facing surface; and
4) placing a release liner to cover a first portion of the removable adhesive, leaving at least a second portion of the removable adhesive uncovered; and
B) providing a suitable envelope for the greeting card; and
C) juxtaposing the greeting card upon the suitable envelope such that the greeting card and the suitable envelope are removably adhered together by the second portion of the removable adhesive.

2. The method of claim 1 wherein the greeting card is detached from the suitable envelope and placed inside the suitable envelope for mailing

3. The method of claim 2 wherein the greeting card is removed from inside the suitable envelope, the release liner is removed from the first adhesive area, and the first adhesive area is used to adhere the greeting card to a display surface.

4. The method of claim 1, wherein the step of converting the greeting card blank into the final shape of the greeting card comprises a folding operation.

5. The method of claim 1, wherein the step C) of juxtaposing the greeting card upon the suitable envelope is carried out such that all surfaces of the greeting card except for the rear outer facing surface may be viewed without detaching the greeting card from the suitable envelope.

6. A method of retaining a greeting card with its intended envelope comprising the steps of:
A) forming a greeting card comprising the steps of:
1) providing a greeting card blank comprising a front panel and an optional one or more additional panels;
2) converting the greeting card blank into the final shape of the greeting card by folding any the optional additional panels; whereby the greeting card has a front outer facing surface and a rear outer facing surface;
3) placing a removable adhesive on at least some portion of the rear outer facing surface; and
B) providing a suitable envelope for the greeting card; and
C) juxtaposing the greeting card upon the suitable envelope such that the greeting card and the suitable envelope are removably adhered together by the removable adhesive.

7. The method of claim 6 wherein the greeting card is detached from the suitable envelope and placed inside the suitable envelope for mailing

8. The method of claim 7 wherein the greeting card is removed from inside the suitable envelope, and the adhesive area is used to adhere the greeting card to a display surface.

9. The method of claim 6, wherein the step of converting the greeting card blank into the final shape of the greeting card comprises a folding operation.

10. The method of claim 6, wherein the step C) of juxtaposing the greeting card upon the suitable envelope is carried out such that all surfaces of the greeting card except for the rear outer facing surface may be viewed without detaching the greeting card from the suitable envelope.

11. A method of retaining a greeting card with its intended envelope comprising the steps of:
A) forming a greeting card comprising the steps of:
1) providing a greeting card blank comprising a front panel and an optional one or more additional panels;
2) converting the greeting card blank into the final shape of the greeting card; whereby the greeting card has a front outer facing surface and a rear outer facing surface;
B) providing a suitable envelope for the greeting card; comprising the step of:
1) placing a removable adhesive on at least some portion of the inside of the envelope; and
C) juxtaposing the greeting card upon the suitable envelope such that the greeting card and the suitable envelope are removably adhered together by the removable adhesive.

12. The method of claim 11 wherein the greeting card is detached from the suitable envelope and placed inside the suitable envelope for mailing

13. The method of claim 11, wherein the step of converting the greeting card blank into the final shape of the greeting card comprises a folding operation.

14. The method of claim 11, wherein the step C) of juxtaposing the greeting card upon the suitable envelope is carried out such that all surfaces of the greeting card except for the rear outer facing surface may be viewed without detaching the greeting card from the suitable envelope.

15. The method of claim 11, wherein a release is used to cover at least a portion of the removable adhesive.
